(19) United States
(12) Patent Application Publication
(10) Pub. No.: US 2014/0259866 A1
(43) Pub. Date: Sep. 18, 2014

(54) FISHING ACCESSORIES FOR THE CONTROLLABLE RELEASE OF SCENT ATTRACTANTS

(71) Applicant: Nathan B. Jones, Lunenberg, MA (US)

(72) Inventor: Nathan B. Jones, Lunenberg, MA (US)

(21) Appl. No.: 13/796,718

(22) Filed: Mar. 12, 2013

(51) Int. Cl. A01K 85/01

(52) U.S. Cl. CPC A01K 85/01
USPC 43/42.06

(57) ABSTRACT

Devices, systems, and related methods are disclosed that generally provide for the controllable release of scent attractants in the vicinity of an implement used to catch or capture fish or other aquatic species. In various embodiments, a fishing accessory is provided that enables an angler to adjust the rate of release of a scent attractant contained within a cavity thereof.

### FIELD

The invention generally relates to apparatus for fishing, and more particularly, to apparatus for the controllable release of fish attractants in the vicinity of a fisherman's lure, hook, or trap.

### INTRODUCTION

Anglers often use artificial lures that mimic the visual appearance of the prey of a target fish. However, fish additionally detect and attack prey using sound, vibration, smell, and taste. For example, fish possess a lateral line, which is a sense organ that can detect movement and vibration in the surrounding water and plays a vital role in its predatory behavior. In combination with the sense of hearing, the lateral line enables a predator fish to determine the location, identity, and size of nearby prey. As such, many artificial lures (e.g., crank baits and rattle baits) can be retrieved in such a manner that produces sounds and/or vibrations that indicate the presence of a wounded baitfish, for example.

Likewise, when fishing with either artificial lures or natural bait (e.g., live bait, cut bait), anglers often take advantage of the well-developed sense of smell and taste of fish to attract them through the use of scented baits or by putting scent attractant directly in the water. Chumming, for example, generally involves the use a perforated “chum bucket” that contains fish parts, blood, and other various scent/taste attractants such that, when tied to the boat and placed in the water, the solids and scent can leach therefrom. While surface chumming can be effective to attract some fish to the general vicinity, the scent can be distributed over too wide an area and/or too quickly dissipated by strong currents. Moreover, surface chumming generally involves a substantial quantity of chum that involves significant cost (e.g., acquiring processed chum) or time and labor (e.g., obtaining and processing bait).

Accordingly, various contraptions have been developed to effect a more targeted delivery of the scent attractants to the area surrounding an angler's bait. For example, artificial lures have been developed that include a chamber into which chum or other scent attractants can be loaded such that the scent is released into the water directly surrounding the bait. Though chum-containing lures provide a greater localized concentration of attractant, they can nonetheless suffer from rapid dispersion of the scent trail due to heavy currents, as discussed above. Moreover, given the increased action experienced by a lure as it is jigged, retrieved, or trolled as well as the chum-containing lure's small capacity relative to that of a chum bucket, the angler is frequently forced to reload the contents of the chum-containing chamber. While every serious angler has developed their own “truths” regarding fishing (e.g., “On cloudy fall days during a rising tide and full moon, you can only catch stripers using a fast retrieve of a yellow plastic eel that is sweetened with a clam”), the most self-evident truth is that you cannot catch fish if your line is not in the water. Despite the theoretical advantage provided by localized chumming, known accessories often force anglers to reel in their lines merely to refill the accessory with attractant.

Accordingly, there remains a need for improved localized scent delivery systems that can control the release of scent over an extended period.

### SUMMARY

In accordance with certain aspects of the present teachings, a fishing accessory is provided that enables an angler to adjust the rate of release of a scent attractant contained therein. In various embodiments, the fishing accessory comprises an outer body securable to a fishing implement and defining an internal cavity configured to receive a material for attracting fish (i.e., the scent attractant). The outer body defines an outer surface, an inner surface, and one or more apertures extending therebetween to allow for fluid communication between the cavity and the outer surface. The fishing accessory can also include an inner member at least partially disposed within the cavity of the outer body and having one or more openings, the inner member configured to impede fluid communication between the cavity and the external surface of the outer body. The outer body and inner member can be movably coupled to one another such that the one or more apertures in the outer body can be at least partially aligned with the one or more openings of the inner member to selectively alter the fluid communication between the cavity and the external surface.

The outer body and inner member can be coupled to one another using a variety of mechanism to allow their relative movement. For example, the outer body and the inner member can be configured to rotate relative to one another. In related aspects, the fluid communication can be adjustable by rotation of the inner member relative to the outer body. Alternatively or additionally, the outer body and inner member can be configured to translate relative to one another.

In some aspects, the inner member comprises a sidewall through which the one or more openings extend, the one or more openings being substantially identical in shape and size to the one or more apertures of the outer body. In related aspects, the inner member can be rotatable between a first position in which the apertures in the outer body are substantially aligned with the openings in the sidewall and a second position in which an effective fluid communication pathway has a reduced diameter.

Fishing accessories in accordance with the present teachings can have a variety of uses. For example, the outer body can be coupled to a variety of fishing implements. In one embodiment, for example, the fishing implement can be a fishing line. Alternatively, the fishing implement can be one of a crab trap or lobster trap.

The fishing accessory can also have a variety of shapes, sizes, and configurations based on the intended use. For example, the outer body can be substantially cylindrical. In some embodiments, the outer body can be shaped as an artificial fishing lure. For example, a fishing hook can be coupled to the outer body. In some embodiments, the outer body can have a fin, for example, to help movement of the fishing accessory through the water. In some embodiments, the outer body can have one or more coupling elements for coupling the outer body to the fishing implement. For example, in an embodiment in which the fishing implement is a fishing line, the coupling element could be a split ring such that the fishing implement can be coupled to the fishing line.

Various scent materials can be used in conjunction with the fishing accessories described herein. For example, the scent material can be a liquid or solid. In some aspects, a sponge disposed in the cavity can be configured to receive a liquid scent material, such as menhaden oil. In some aspects, the scent material can include solids (e.g., fish pieces). In related aspects, a mesh material could be disposed across the apertures to help retain larger pieces of the solid scent material within the cavity.

In various embodiments, the outer body can include one or more removable endcaps. In related aspects, the apertures can extend through one or more of the endcaps. In some embodiments, the fishing accessory can include indicia (e.g., markings) that indicate the effective fluid flow rate (e.g., fast, medium, slow).

These and other features of the applicants' teachings are set forth herein.

### BRIEF DESCRIPTION OF THE DRAWINGS

The skilled person in the art will understand that the drawings, described below, are for illustration purposes only. The drawings are not intended to limit the scope of the applicants' teachings in any way.

FIG. 1, in schematic diagram, illustrates an exemplary fishing accessory coupled to a fishing implement in accordance with various aspects of the applicant's teachings.

FIG. 1A, in schematic diagram, illustrates another exemplary fishing accessory coupled to a fishing implement in accordance with various aspects of the applicant's teachings.

FIG. 1B is a partially exploded view of the fishing accessory of FIGS. 1 and 1A.

FIG. 2A, in a schematic diagram, illustrates another exemplary fishing accessory in accordance with various aspects of the applicant's teachings.

FIG. 2B is a partially exploded view of the fishing accessory depicted in FIG. 2A.

FIG. 3A, in schematic diagram, illustrates another exemplary fishing accessory in accordance with various aspects of the applicant's teachings.

FIG. 3B is a partially exploded view of the fishing accessory depicted in FIG. 3A.

FIG. 4, in schematic diagram, illustrates another exemplary fishing accessory in accordance with various aspects of the applicant's teachings.

FIG. 5A, in schematic diagram, illustrates another exemplary fishing accessory in accordance with various aspects of the applicant's present teachings.

FIG. 5B, in schematic diagram, illustrates another view of a portion of the fishing accessory depicted in FIG. 5A.

### DETAILED DESCRIPTION

Certain exemplary embodiments will now be described to provide an overall understanding of the principles of the structure, function, and use of the systems and devices disclosed herein. One or more examples of these embodiments are illustrated in the accompanying drawings, which are not necessarily to scale. Those skilled in the art will appreciate that the systems and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Devices, systems, and related methods are disclosed that generally provide for the controllable release of scent attractants in the vicinity of an implement used to catch or capture fish or other aquatic species. In various embodiments, a fishing accessory is provided that enables an angler to adjust the rate of release of a scent attractant contained within an inner cavity thereof. It should be appreciated that though the term “fishing” is frequently used throughout this description, the present teachings provide devices and methods that can provide for the localized, controllable release of scent-exuding materials for attracting not only fish per se, but also other aquatic species responsive to such materials (e.g., crabs, lobsters).

Scent attractants for use in the devices and methods can take a variety of forms and are generally referred to herein as “chum.” As will be appreciated by a person skilled in the art, chum can be a liquid, emulsion, or pellets and other solids that commonly contain whole fish (e.g., herring, menhaden, squid), its parts (e.g., chunk bait, fish meal, blood, oil), and/or manufactured scent materials (e.g., artificial attractants). Additionally, a sponge or other material (e.g., cotton fibers) soaked in the scent material can be disposed in the cavity of the fishing accessory.

With reference to FIG. 1, an exemplary embodiment of a fishing accessory 100 for the controllable release of chum is depicted in combination with a fishing implement. As shown in FIG. 1, the fishing accessory 100 is coupled to a fishing line 102 at a location near an artificial lure 104 such that chum contained within the fishing accessory 100 can be released into the water in the vicinity of the lure 104 through one or more apertures 122 formed in an outer body 120 of the fishing accessory 100. As will be discussed in detail below, the fishing accessory 100 can also contain an inner member 140 (shown partially in phantom) that is movably coupled to the outer body 120 such that a user can control the size of the fluid flow pathway, and ultimately, the flow rate of scent into the water surrounding the fishing implement. Accordingly, the effective flow rate can be selected by the angler based, for example, on the angler's experience, water temperature, current speed, trolling speed, depth, lure action, duration of submersion, etc.

With reference now to FIG. 1A, an alternative embodiment of a fishing accessory 100A for the controllable release of chum is depicted in combination with a fishing implement for cod or bottom fishing. In FIG. 1A, the fishing accessory 100A is similarly coupled to a fishing line 102A at a location near an artificial lure 104A such that chum contained within the fishing accessory 100A can be released into the water in the vicinity of the lure 104A through one or more apertures 122A formed in an outer body 120A of the fishing accessory 100A. In this embodiment, the fishing line also includes a weight 103 and additional baited hooks 105

It will be appreciated that fishing accessories in accordance with the present teachings can be associated with any fishing implement known in the art, including fishing line, artificial lures, baited hooks, floats, bobbers, nets, crab traps, and lobster pots, all by way of non-limiting example. It will further be appreciated that the fishing accessories described herein can be associated with and/or coupled to the fishing implement in any manner known in the art. By way of example and with specific reference to FIG. 1A, the fishing accessory 100 can include one or more eyes or split rings 106 that can be utilized to fixedly or movably couple the accessory 100 to the fishing line 102. For example, the fishing line 102 can be inserted into the split ring 106 before or after the artificial lure 104 has been coupled to the fishing line 102 (e.g., without cutting the line). In such a manner, the accessory 100 can be removable, slidably disposed along the fishing line 102 (e.g., between two swivels), and/or retained a desired distance from the artificial lure 104 or baited hook (e.g., less than 3 feet, less than 2 feet, less than 1 foot). Alternatively, the fishing line 102 can be tied directly to the fishing accessory 100 (e.g., to the upper split ring 106 or otherwise), with the lower split ring 106 being coupled to a heavier-gauge leader, for example. It will further be appreciated that any number of variations in the terminal tackle can accommodate the fishing accessories described herein. By way of example, reel line can be tied directly to a fishing accessory 100 having a plurality of leaders extending therefrom. In embodiments in which the fishing accessories described herein are used with fishing implements such as crab/lobster traps, for example, the fishing accessory can be directly coupled to the trap (e.g., clipped or tied) or simply placed therein. It will additionally be appreciated that the trap itself can be manufactured to include an integrated fishing accessory in light of the present teachings.

With specific reference to FIG. 1B, the exemplary fishing accessory 100, which is shown in exploded view, generally includes an outer body 120 and an inner member 140 that is configured to be at least partially disposed within the outer body 120. The outer body 120 can have a variety of configurations but generally defines an internal cavity 124 that is configured to contain chum. The outer body 120 additionally includes one or more apertures 122 that extend from the cavity 124 through the outer body 120 between an inner surface 126 and an outer surface 128 thereof and which enable fluid communication between the cavity 124 and the outer surface 128. Additionally, in the depicted embodiment, the outer body 120 extends between an open proximal end 120p and a closed, distal end 120d having a coupling mechanism (e.g., split ring 106) extending therefrom for coupling the fishing accessory 100 to the fishing line 102, for example, as discussed above.

The inner member 140 can also have a variety of configurations but is generally configured to be at least partially disposed within the outer body 120 and be movably coupled thereto. As shown in FIG. 1B, the inner member 140 includes a sidewall 148 that extends between a closed, proximal end 140p and an open distal end 140d and defines a chamber 144. In an exemplary embodiment, the inner member 140 can be dimensioned such that its sidewall 148 substantially seals against the inner surface 126 of the outer body 120 when the inner member 140 is at least partially disposed therein. In such a manner, fluid can be substantially prevented from flowing between the sidewall 148 of the inner member 140 and the inner surface 126 of the outer body 120.

Like the outer body 120, the sidewall 148 of the inner member 120 can also include one or more openings 142 that provide a fluid flow pathway between the internal chamber 144 of the inner member 140 and its outer surface. Thus, when the apertures 124 of the outer body 120 are at least partially aligned with the openings 144 of the inner member 140, a fluid flow pathway can be established between the outer surface 128 of the outer body 120 and the chamber 144 of the inner member 140. Conversely, when the outer body 120 and inner member 140 are positioned relative to one another such that the sidewall 148 of inner member 140 fully occludes the apertures 122 in the outer body 120, fluid cannot flow from inside the chamber 144 to the outer surface 128 of the outer body 120, such that the chum contained within the cavity 124 (and in the chamber 144) is largely retained therein.

As noted above, the inner member 140 and outer body 120 can be coupled to one another so as to enable their relative movement. In such a manner, the inner member 140 can be selectively positioned relative to the outer body 120 so as to adjust the size (e.g., diameter) of the fluid flow pathway between the outer surface 128 and inner cavity 124. By way of example, the fluid flow rate can be maximized by fully aligning the openings 142 in the inner member 140 with the apertures 122 in the outer body 120 and minimized when the sidewall 128 of the inner member 120 fully occludes the apertures 122 in the outer body 120. Alternatively, the inner member 140 and outer body 120 can be selectively positioned relative one another such that the apertures 122 and openings 142 are only partially aligned. It will thus be appreciated by a person skilled in the art that by adjusting the alignment of the various apertures 122 and openings 142, the effective fluid flow pathway between the cavity and the outside of the fishing accessory can be altered.

The inner member 140 and the outer body 120 can be movably coupled using a variety of mechanisms that allow for the selective alignment of the apertures 122 and openings 142. By way of example, in the exemplary embodiment depicted in FIG. 1B, the inner surface 126 of the outer body 120 includes threads 128 (shown in phantom) at the distal end 120d that are configured to mate with threads 148 formed on the distal end 140d of the inner member 140. Accordingly, when the inner member 140 is inserted into the outer body 120, the threads 128, 148 can engage and allow for the rotational and longitudinal movement of the inner member 140 and outer body 120 relative to one another. It will be appreciated that in some embodiments, the thread size and pitch can be configured in light of the length of the various portions of the fishing accessory 100 such that the apertures 122 and openings 142 can be moved between full alignment and full occlusion when the threads of the outer body 120 and inner member 140 are engaged. Alternatively, it will be appreciated that based on the size and shape of the various apertures 122 and openings 142, and/or on the ability of the inner member 140 and outer body 120 to move relative to one another, in some embodiments, the fishing accessory 100 can be configured such that a fluid flow pathway always exists between the outer surface 128 of the outer body 120 and the cavity 124 through one or more apertures 122, thus allowing fluid flow from the fishing accessory 100 even when the open, proximal end 120p of the outer body 120 and open, distal end 140d of the inner member 140 are sealed. In such an embodiment, the position of the inner member 140 and outer body 120 could be indicated as the minimum fluid flow rate position with markings disposed on the fishing accessory, for example. Likewise, the relative position of the inner member 140 and the outer body 120 at the maximum fluid flow rate can additionally, or alternatively be indicated.

With reference now to FIGS. 2A and 2B, another exemplary embodiment of a fishing accessory 200 in accordance with the present teachings is depicted. The fishing accessory 200 is similar to that of FIGS. 1A and 1B in that the fishing accessory 200 includes an outer body 220 having a plurality of apertures 222 to provide for fluid communication between an outer surface 228 and the cavity 224. Likewise, as with the inner member 140 of FIGS. 1A and 1B, the inner member 240 includes a sidewall 248 defining an inner chamber 244 and having a plurality of openings 242 apertures extending therethrough.

However, the fishing accessory 200 differs in that the inner member 240 and outer body 220 are configured to be movably coupled to one another by friction fit. For example, the sidewall 248 of the inner member 240 and the inner surface 226 of the outer body 220 can be dimensioned such that frictional forces between at least a portion of the inner member 240 and outer body 220 can substantially prevent their relative movement under typical operating conditions (e.g., jigging, trolling), while still enabling an angler to adjust their relative position in order to alter the size of the fluid flow pathway. Moreover, in some aspects, a sealing element can be provided to help ensure solid coupling of the inner member 240 and outer body 220. For example, rubber gaskets 248 disposed around the circumference of the inner member 240 can provide locations of additional frictional coupling and/or improved sealing to prevent chum eluting from cavity 224 in a non-desired direction. Thus, as best shown in FIG. 2B, in various aspects, the movable coupling of the inner member 240 to the outer body 220 can enable the relative longitudinal movement of the apertures 222 and openings 242 and/or their relative rotational movement. That is, the alignment of the apertures 222 and openings 242 can be adjusted by twisting the inner member 240 relative to the outer body 220 and/or by partially withdrawing or further inserting the inner member 240 relative to the outer body 220.

The exemplary fishing accessory 200 also differs from that depicted in FIGS. 1A and 1B in that the fishing accessory 200 additionally includes an end cap 260 that can be removably coupled to the distal end 220d of the outer body 220, for example, via threading as depicted in FIG. 2A, or through any other coupling mechanism known in the art (e.g., friction fit). In use, the end cap 260 can enable the angler to refill the cavity 224 with chum, for example, without having to alter the relative position of the outer body 220 and the inner member 240 (e.g., in the case that a particular effective flow rate is found especially advantageous in light of the fishing conditions). It will further be appreciated that though the end cap 260 is coupled to the outer member 220 in the depicted embodiment, the proximal end 240p of the inner member 240 can additionally or alternatively be configured to be selectively opened.

Additionally, the fishing accessory 200 differs in that the apertures 222 in the outer body 220 and the openings 242 in the inner member 240 depicted in FIGS. 2A and 2B are circular rather than diamond-shaped as in FIGS. 1A and 1B. Indeed, it will be appreciated that the apertures 222 and openings 242 in the outer body 220 and inner member 240 can have a variety of shapes and sizes, and can be the same or different as one another. By way of example, the openings 242 through the inner member 240 can be small circles while the apertures 222 through the outer body 220 can be large diamonds or squares, so long as the openings 242 and apertures 222 can at least partially be aligned so as to provide a fluid flow path from the cavity 244. Moreover, the openings 242 in the inner member 240, for example, need not be the same size or shape as one another. Similarly, the plurality of apertures 222 in the outer body 220 can have different configurations from one another. In some aspects, a mesh material that covers the openings or apertures may be useful when the openings and apertures have a larger diameter than solid chum pieces contained within the cavity.

As depicted in FIGS. 3A and 3B, another exemplary embodiment of a fishing accessory 300 in accordance with various aspects of the present teaching includes a single opening (e.g., slot 342) formed in the sidewall 348 of the inner member 340. As discussed otherwise herein, rotation of the inner member 340 relative to the outer body 320 can be effective to at least partially align the slot 342 with a plurality of the diamond-shaped apertures 322 to allow fluid flow between the cavity 324 and the outer surface 328 of the outer body 320. It will further be appreciated that though the depicted embodiments have a plurality of openings extending along only a single side of the outer body, the openings and apertures can extend through the inner member and outer body in various radial positions. For example, the outer body 320 and inner member 340 could have identical diamond-shaped apertures and an identical slot on their opposed sides (not shown) such that fluid can flow from the cavity 324 on both sides of the fishing accessory 300. Alternatively, for example, the unseen side of the fishing accessory 300 could have smaller diamond-shaped apertures (or differently shaped apertures) such that the flow rate can be selected by aligning the slot 342 with the opposed apertures. Further, it should be understood to be within the ordinary skill of one in the art to modify the longitudinal and/or radial placement of the one or more aperture(s) and the one or more opening(s) as warranted by various considerations to achieve different flow rates of scent out of the fishing accessories described herein. Moreover, as discussed above, indicators can be provided on the device to provide a user a visual guide in the flow rates provided by a selected relative positioning of the outer body and inner member.

It will further be appreciated based on the teachings herein that the shape and size of the fishing accessories can also vary depending, for example, on the intended use. By way of example, in the exemplary embodiments discussed above which can be coupled to a fishing line adjacent to the angler's bait or lure, for example, the fishing accessory can have a length in the range of between 2 inches and 1 foot and a width or outer diameter (OD) in the range of about ⅜ inch to about 2 inches. (It will be appreciated that commercial fishing accessories can be even larger than these exemplary size ranges.)

Alternatively, fishing accessories in accordance with the present teachings can also be used to target crustaceans (e.g., crab, lobster) by coupling the fishing accessory to a trap. Because these traps are left submerged for extended periods of time, larger fishing accessories can be used to accommodate the increased volume of attractant (e.g., often whole, large fish). While the present teachings can enable the controlled release of the scent attractant from fishing accessories useful for targeting crab and lobster as otherwise discussed herein, these fishing accessories can also be useful in preventing captured crustaceans from consuming the attractant contained therein. For example, by decreasing the size of the fluid flow pathways in a trap to left submerged for an especially extended period of time, the angler can also prevent access to the attractant contained within the inner cavity. Accordingly, in embodiments particularly useful in crab and lobster traps, the fishing accessory can have a length in the range of between 6 inches and 18 inches and a width or outer diameter (OD) in the range of about 2 inches to about 4 inches.

Further, though the exemplary embodiments discussed above are depicted as being substantially cylindrical, it will be appreciated that the teachings herein can be applied to produce fishing accessories of alternative cross-sectional shapes (e.g., square, triangle). By way of example, the fishing accessory 200 depicted in FIGS. 2A and 2B could have a triangular cross-section, with alignment of the apertures 222 and openings 242 being adjusted by withdrawing or further inserting the inner member 240 relative to the outer body 220. It will further be appreciated that the overall shape of fishing accessories in accordance with the present teachings can be modified, for example, to improve the hydrodynamics and/or decrease fouling of the angler's fishing line. As shown in FIGS. 3A and 3B, for example, the outer body 320 can include fins 307 that can prevent rotation of the fishing accessory 300 about its longitudinal axis as it descends through the water column or is drug behind a boat and in front of a trolling lure.

Additionally, fishing accessories in accordance with the present teachings can be manufactured to be in the form of an artificial lure that contains and controllably releases chum. With reference now to FIG. 4, an exemplary fishing accessory 400 is depicted in which the outer body 420 is shaped and sized to represent a lure. The fishing accessory 400 is similar to those discussed above in that it includes an outer body 420 having apertures 422 formed therethrough and an inner member 440 that is configured to move relative thereto so as to control that rate of fluid flow through the apertures 422. Additionally, as shown in FIG. 4, the fishing accessory 400 includes an end cap 460 that can be removably coupled to the outer body 440, for example, via threading or through any other coupling mechanism known in the art (e.g., friction fit). The endcap 460 can additionally include a threaded bore 462 that is configured to receive a threaded end 440p of a rod 440 that extends through the outer body 420. The rod 440 also extends through a bore in the tail end of the fishing accessory and terminates in a tail-shaped member 440d. It will be appreciated that the bore in the outer body 420 can provide a seal against the rod 420 to prevent leakage of chum contained within the cavity of the outer body 420 therethrough. In use, after filling the cavity of the outer body 420 with chum, the endcap 460 can be replaced (e.g., coupled with the outer body 420) and the tail-shaped member 440d can be manipulated by the angler to advance and/or rotate the rod 440 within the cavity to couple the threaded end 440p of the rod 440 to the threaded bore 462. As will be appreciated in light of the teachings herein, the rod 440 can also be manipulated (e.g., rotated) such that one or more radial projections (e.g., sidewall 428 shown in phantom) can selectively occlude the apertures 422 to control the effective fluid flow pathway.

It will be appreciated in light of the present teachings that the size, shape, number and configuration of the openings to chum-containing cavity in the exemplary fishing accessories can differ depending on the intended use, effectiveness of a particular set-up, etc. For example, with reference now to FIGS. 5A and 5B, another exemplary fishing accessory 500 is depicted. Though this fishing accessory 500 can be preferred when trolling, for example, it will be appreciated that various trolling, jigging, and retrievable lures known in the art can be modified in light of the present teachings to enable the controlled release of scent attractant therefrom. With specific reference to FIG. 5A, for example, the exemplary fishing accessory 500 comprises a tubular outer body 520 extending along a longitudinal axis between a proximal end cap 560p and a distal end cap 560d. Whereas in the previous exemplary embodiments, the openings in the outer body extended substantially radially therethrough, in the exemplary fishing accessory 500 depicted in FIGS. 5A and 5B, one or more apertures 522 extend through the endcaps 560p,d in a direction substantially parallel to the longitudinal axis of the fishing accessory 500.

As in the above exemplary embodiments, the fluid flow pathway between the cavity 524 and the outer surface 528 of the outer body 520 can be altered so as to control the release of chum contained within the inner cavity 524. For example, with reference now to FIG. 5B, which depicts the inside of the exemplary endcap 560p, the apertures 522 in the end cap 560p can be selectively occluded by the separated, solid wings 548 of an inner member 540 that is rotatably coupled to the inner surface 526 of the endcap 560p (e.g., by a rivet, screw, etc.). Accordingly, by aligning portions of the wings 548 with the apertures, the size of the fluid flow pathway can be altered. Though not shown, the endcap 560p can also have an inner member rotatably coupled thereto such that apertures 522 in both the upstream and downstream endcaps 560p,d can be at least partially occluded to control fluid flow through the cavity 524, and thus, release of scent in a scent trail, as the fishing accessory 500 is trolled substantially along its longitudinal axis behind a boat. It will additionally be appreciated that though the “inner” member 540 is described as being disposed within the endcap 560p (e.g., against its inner surface), the fishing accessories described herein can alternatively include one or more occlusion members that be inserted into the apertures or cover the apertures to selectively occlude the fluid flow pathway from the chum-containing cavity.

It will also be appreciated that fishing accessories in accordance with the present teachings can be composed of various materials, but in some preferred embodiments can comprise materials that can be repeatedly exposed to saltwater without incurring significant damage and/or rust. Exemplary materials include plastics (e.g., PVC) and various metals (e.g., stainless steel), by way of non-limiting example.

What is claimed is:

1. A fishing accessory, comprising:
an outer body securable to a fishing implement and defining an internal cavity configured to receive a scent material for attracting fish, the outer body defining an outer surface, an inner surface, and one or more apertures extending therebetween to allow for fluid communication between the cavity and the outer surface,
an inner member having one or more openings and at least partially disposed within the cavity of the outer body, the inner member configured to impede fluid communication between the cavity and the external surface of the outer body,
wherein the outer body and inner member are movably coupled to one another such that the one or more apertures in the outer body are configured to be at least partially aligned with the one or more openings of the inner member so as to selectively alter the fluid communication between the cavity and the external surface.

2. The fishing accessory of claim 1, wherein the outer body and the inner member are configured to rotate relative to one another.

3. The fishing accessory of claim 2, wherein fluid communication is adjustable by rotation of the inner member relative to the outer body.

4. The fishing accessory of claim 1, wherein the inner member comprises a sidewall through which the one or more openings extend, wherein the one or more openings are substantially identical in shape and size to the one or more apertures of the outer body.

5. The fishing accessory of claim 4, wherein the inner member is rotatable between a first position in which the apertures in the outer body are substantially aligned with the openings in the sidewall and a second position in which an effective fluid communication pathway has a reduced diameter.

6. The fishing accessory of claim 1, wherein the outer body and inner member are configured to translate relative to one another.

7. The fishing accessory of claim 1, wherein the outer body is coupled to a fishing implement.

8. The fishing accessory of claim 1, wherein the fishing implement comprises a fishing line.

9. The fishing accessory of claim 1, wherein the fishing implement comprises one of a crab trap or lobster trap.

10. The fishing accessory of claim 1, wherein the outer body is substantially cylindrical.

11. The fishing accessory of claim 1, wherein the outer body is shaped as an artificial fishing lure.

12. The fishing accessory of claim 14, further comprising a fishing hook coupled to the outer body.

13. The fishing accessory of claim 1, wherein the wherein the outer body comprises a fin.

14. The fishing accessory of claim 1, further comprising a sponge disposed in the cavity, wherein the sponge is configured to receive a liquid scent material.

15. The fishing accessory of claim 1, wherein the scent material comprises solid scent material.

16. The fishing accessory of claim 1, wherein the outer body comprises one or more removable endcaps.

17. The fishing accessory of claim 16, wherein the apertures are formed in the one or more endcaps.

18. The fishing accessory of claim 1, wherein the outer body comprises one or more coupling elements for coupling the outer body to the fishing implement.

19. The fishing accessory of claim 18, wherein the fishing implement is a fishing line and the coupling implement comprises a split ring.

20. The fishing accessory of claim 1, further comprising an indicia of an effective fluid flow rate.
